(19) United States
(12) Patent Application Publication
(10) Pub. No.: US 2006/0212888 A1
(43) Pub. Date: Sep. 21, 2006

(54) POSITIONING APPARATUS FOR DATA STORAGE DEVICE

(76) Inventor: Ku-Feng Chen, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/160,858

(22) Filed: Jul. 13, 2005

(30) Foreign Application Priority Data
Mar. 21, 2005 (TW) 94204336

(51) Int. Cl. G11B 33/02

(52) U.S. Cl. 720/657

(57) ABSTRACT

A positioning apparatus for a data storage device is provided to firmly install the data storage device in a frame, to conveniently assemble/disassemble the data storage device on/from the frame, to reduce manufacturing costs and to reduce assembly steps. The positioning apparatus for the data storage device comprises a first locking part and a locking module. The first locking part connects with the data storage device. The locking module comprises a body, a second locking part, and an elastomer. When the data storage device is installed at the preset location of the frame along the first direction, the elastomer of the locking module installed along the second direction and outside of the frame forces the second locking part to restrain the moving of the first locking part along the first direction. The data storage device can be disassembled from the frame by removing the restraint described above.

### CROSS-REFERENCE TO RELATED APPLICATION

This application claims the priority benefit of Taiwan application serial no. 94204336, filed on Mar. 21, 2005. All disclosure of the Taiwan application is incorporated herein by reference.

### BACKGROUND OF THE INVENTION

1. Field of the Invention

The present invention relates to a positioning apparatus, and more particularly, to a positioning apparatus for a data storage device.

2. Description of the Related Art

For a traditional method of installing a data storage device, fixing parts are disposed on two sidewalls of the data storage device. The data storage device slides and is installed in a frame. By using locking parts of the frame and the locking parts on the fixing parts, the data storage device is firmly installed and locked in the frame.

FIG. 1 is a 3-D explosion drawing of a conventional positioning apparatus for a data storage device. Referring to FIG. 1, the conventional positioning apparatus for the data storage device includes a frame 10, a data storage device 20, a pair of ground clips 30 and a pair of fixing parts 40. When the data storage device 20 is to be installed, the ground clips 30 are disposed in the body 50 of the fixing parts 40. Then screws are used to fix the ground clips 30 on the outer walls of the data storage device 20 so that the ground clips 30 are disposed between the fixing parts 40 and the data storage device 20. The data storage device 20 is installed in the frame 10 following the direction parallel to the frame bottom plate 12 and along the direction of the support sheets 16 on the sidewalls 14 of the frame 10 until the locking parts 62 of the fixing parts 40 lock the locking openings 18 at the front edge of the frame 10. Meanwhile, the strip blocks 64 of the fixing parts 40 are disposed outside of the front edge of the sidewalls 14 of the frame 10 so that the data storage device 20 can be installed at the preset location of the frame 10.

If the data storage device 20 is to be removed, the grips 70 of the fixing parts 40 should be pulled outwardly in the direction opposite to the internal of the frame 10. It means that the pulling direction should be opposite to the direction which the data storage device 20 is installed. Accordingly, the elastic locking blocks 62 move toward the outer wall of the data storage device 20 so that the elastic locking blocks 62 are removed from the locking opening 18 at the front edge of the frame 10. The grips 70 are continuously pulled until the data storage device 20 is completely removed from the inside of the frame 10.

However, the structure of the conventional positioning apparatus for the data storage device is very complicated. For the fixing parts disposed on two sidewalls of the data storage device, separable elements comprise the body, the grips and the ground clips. In other words, at least six elements are required on two sidewalls of a single data storage device. The many separable elements cause high manufacturing costs and assembly steps.

### SUMMARY OF THE INVENTION

Accordingly, the present invention is directed to a positioning apparatus for a data storage device to firmly install the data storage device on the frame and to conveniently assemble/disassemble the data storage device on/from the frame.

In addition, the present invention is also directed to a positioning apparatus for a data storage device to reduce manufacturing costs of and assembly steps the positioning apparatus for the data storage device.

In order to achieve the objects above, the present invention provides a positioning apparatus for a data storage device. The positioning apparatus is adapted to install the data storage device in a frame, wherein the data storage device is movable in the frame along a first sliding direction. The position apparatus for the data storage device comprises at least a first locking part and a locking module. The first locking part connects with the data storage device. The locking module comprises a body, a second locking part and an elastomer. Wherein, the body is movable outside of the frame along a second sliding direction; the second locking part connects with the body; and the elastomer is disposed between the body and the frame, and enforces a bias force to the body relatively to the frame.

When the data storage device is at a preset location of the frame, the elastomer forces the second locking part to restrain the first locking part to move along the first sliding direction. When the body moves along the second sliding direction, the second locking part will not restrain the first locking part to move along the first sliding direction. The data storage device is adapted by an external force to move away from the preset location along the first sliding direction.

According to a preferred embodiment of the present invention, the elastomer forces the second locking part to unilaterally restrain the first locking part to move along the first sliding direction so that the data storage device is forced to stay at the preset location.

According to a preferred embodiment of the present invention, the positioning apparatus for the data storage device further comprises a first stopping part and a second stopping part, for example. The first stopping part connects with the data storage device. The second stopping part corresponds to the first stopping part and connects with the frame. When the data storage device is at the preset location, the second stopping part at least restrains the first stopping part to move along the first sliding direction so as to restrain the data storage device at the preset location to move along the first sliding direction.

Accordingly, the positioning apparatus for the data storage device not only conveniently assembles/disassembles the data storage device on/from the frame and firmly installs the data storage device on the frame, but also substantially reduces the number of separable elements of the positioning apparatus for the data storage device so as to reduce manufacturing costs of and assembly steps for the positioning apparatus for the data storage device.

The above and other features of the present invention will be better understood from the following detailed description of the preferred embodiments of the invention that is provided in communication with the accompanying drawings.

### BRIEF DESCRIPTION OF THE DRAWINGS

FIG. 1 is a 3-D explosion drawing of a conventional positioning apparatus for a data storage device.

FIG. 2A is a 3-D drawing showing pre-assembly of a data storage device and a frame by a positioning apparatus for the data storage device according to an embodiment of the present invention.

FIG. 2B is another 3-D drawing of the frame of FIG. 2A.

FIG. 2C is another 3-D drawing showing a fixing part and the data storage device of FIG. 2A.

FIG. 3A is a front view of the locking module of FIG. 2A.

FIG. 3B is a rear view of the locking module of FIG. 2A.

FIG. 4 is a 3-D drawing of the fixing part of FIG. 2A.

FIG. 5A is a side view when a data storage device and a frame are assembled through the positioning apparatus for the data storage device of FIG. 2A.

FIG. 5B is an enlarged local cross sectional view of FIG. 5A.

FIG. 6 is a schematic cross sectional view showing that a second locking part restrains a first locking part according to another embodiment of the present invention.

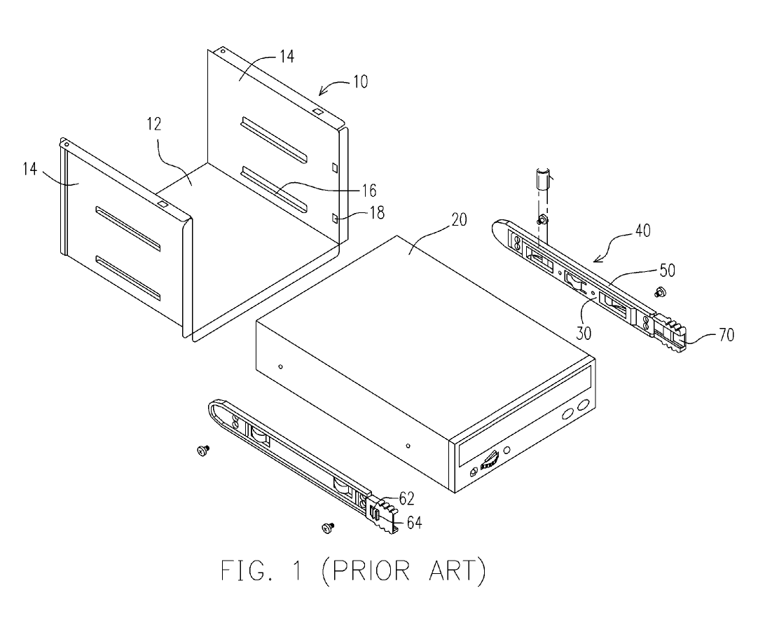

### DESCRIPTION OF SOME EMBODIMENTS

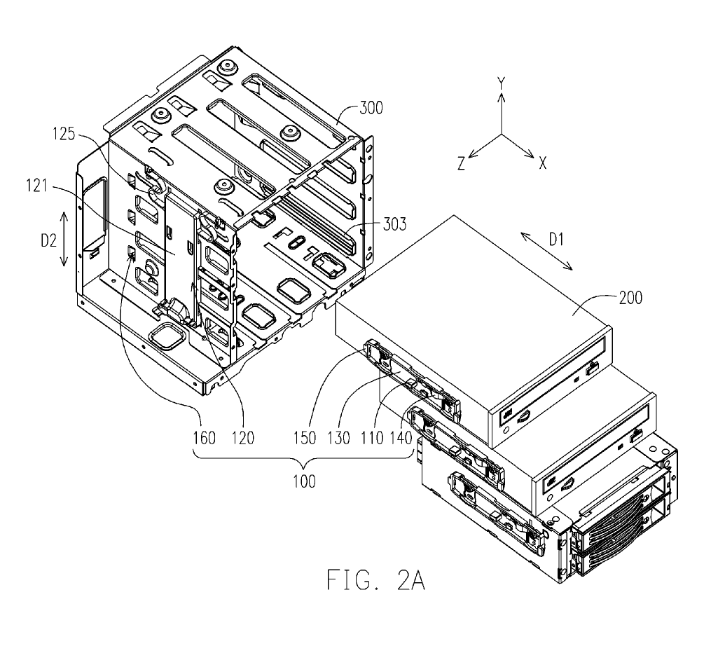

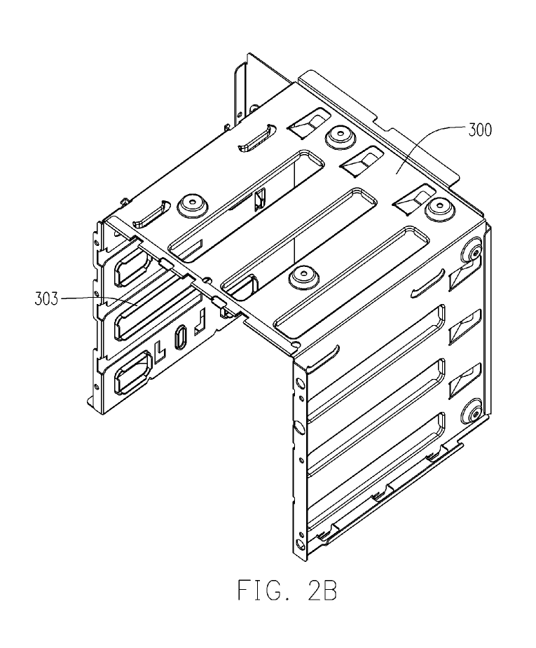

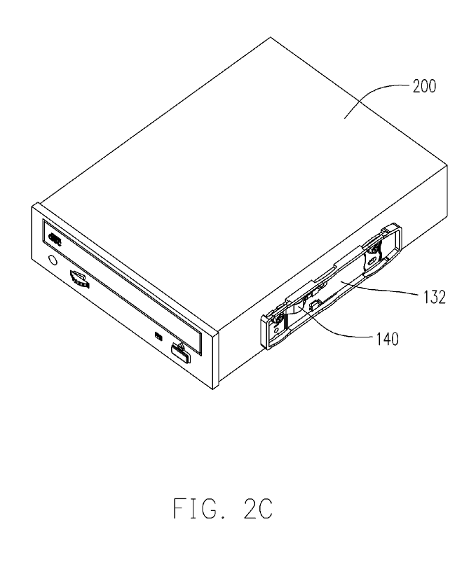

FIG. 2A is a 3-D drawing showing pre-assembly of a data storage device and a frame by a positioning apparatus for the data storage device according to an embodiment of the present invention. FIG. 2B is another 3-D drawing of the frame of FIG. 2A. FIG. 2C is a another 3-D drawing showing a fixing part and the data storage device of FIG. 2A. Referring to FIGS. 2A-2C, the positioning apparatus 100 for a data storage device 200 according to an embodiment of the present invention is adapted to install the data storage device 200 on a frame 300. The data storage device 200 is movable in the frame 300 along a first sliding direction substantially parallel to the X-axis. The positioning apparatus 100 comprises a first locking part 100, a locking module 120, two fixing parts 130 and 132, two ground clips 140, a first stopping part 150, and a second stopping part 160. Each of the fixing parts 130 and 132 individually connects with one of the two side surfaces of the data storage device 200 as shown in FIGS. 2A and 2C. The locking module 120 is movable outside the frame 300 along a second sliding direction substantially parallel to the Y-axis. Additionally, the frame 300 comprises at least a pair of support sheets 303 to support the fixing parts 130 and 132 on the two side surfaces of the data storage device 200, respectively, so that the data storage device 200 is movable and installed in the frame 300 along the first sliding direction D1 substantially parallel to the X-axis.

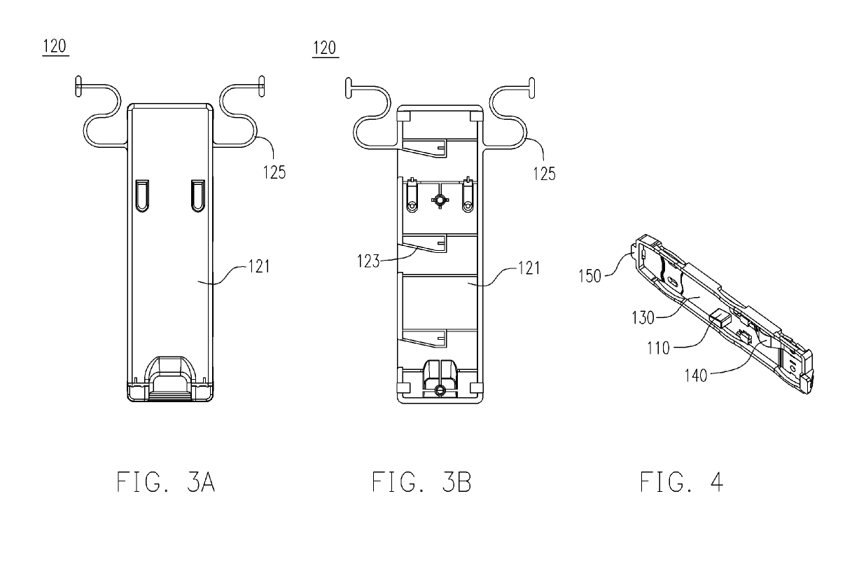

FIG. 3A is a front view of the locking module of FIG. 2A. FIG. 3B is a rear view of the locking module of FIG. 2A. Referring to FIGS. 2A, 3A and 3B, the locking module 120 comprises a body 121, a second locking part 123 and an elastomer 125. They can be integrated as a unity, for example, and the material thereof can be, for example, plastic. The position of the second locking part 123 corresponds to that of the first locking part 110, and the second locking part 123 connects with the body 121. Two ends of the elastomer 125 connect with the body 121 and the frame 300. The elastomer 125, relative to the frame 300, moves along the second sliding direction D2 and applies a bias force to the body 121 along the negative direction of the Y-axis. The elastomer 125 can be a spring or a clip. In this embodiment, the elastomer 125 is a pair of S-shape elastic strips. The present invention, however, is not limited thereto.

FIG. 4 is a 3-D drawing of the fixing part of FIG. 2A. Referring to FIGS. 2A and 4, the first locking part 110 and the first stopping part 150 integrated as a whole connect with the fixing part 130. The fixing part 130 connects with the data storage device 200. For example, the fixing part 130 connects with the data storage device 200 by screws. Additionally, the conductive ground clips 140 connect with the fixing parts 130 and 132 individually (FIG. 2C) to form a curve structure. The concave surface of the curve structure faces to the data storage device 200. The first locking part 110 and the first stopping part 150 are extrusions. Referring to FIG. 2A, the second stopping part 160 connects, and is integrated, with the frame 300 to form a concave. Its structure is adapted to accommodate the first stopping part 150.

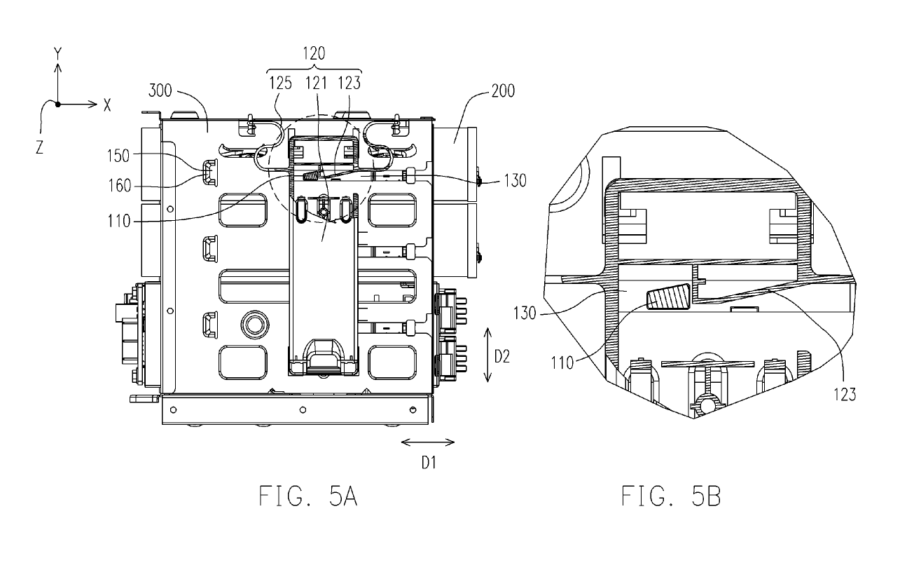

FIG. 5A is a side view when a data storage device and a frame are assembled through the positioning apparatus for the data storage device of FIG. 2A. FIG. 5B is an enlarged local cross sectional view of FIG. 5A. In order to show the relative positions of the first locking part 110 and the second locking part 123, the local area of FIG. 5A is shown with a cross sectional view. Though the drawings of FIGS. 5A and 5B show the relative positions of the data storage device 200 in the frame 300 after assembly, the position of the locking module 120 does not change after assembly.

Referring to FIGS. 2A-2C, 5A and 5B, when the data storage device 200 is to be installed on the frame 300, the fixing parts 130 and 132 connecting with the sidewalls of the data storage device 200 and the bottom of the fixing parts 130 and 132 follow the support sheet 303 and move upwards along the first sliding direction D1 in the negative direction of the X-axis toward the inside of the frame 300. When the first locking part 110 touches the second locking part 123, the surface between them is a tilt plane, compared with the XZ plane. As a result, the second locking part 123 is subject to a force from the first locking part 110, which is vertical to the surface. The Y-axis component of the force offsets the bias force on the body 121 from the elastomer 125 so that the second locking part 123 moves along the second sliding direction D2 and the positive direction of Y-axis. The data storage device 200 thus moves along the first sliding direction D1 and in the negative direction of the X-axis toward the inside of the frame 300 until the first stopping part 150 touches the second stopping part 160. At this moment, the data storage device 200 is at the preset location of the frame 300 and the extrusions of the ground clips 140 touch the internal surfaces of the frame to achieve the grounding purpose.

When the data storage device 200 is at the preset location, the first locking part 110 and the second locking part 123 are not in contact. As a result, the second locking part 123 is only subject to the bias force on the body 121 from the elastomer 125 and returns to the original location before the data storage device 200 is assembled.

Referring to FIGS. 5A and 5B, the assembled data storage device 200 can be fixed at the preset location by two manners. The first manner uses the position of the first locking part 110 relative to the position of the second locking part 123 of the locking module 120. The relative position of the first locking part 110 to the second locking part 123 makes the second locking part 123 unilaterally restrain the moving of the first locking part 110 along the first sliding direction D1. The reason that the second locking part 123 performs the function described above is that the elastomer 125 connecting with the frame 300 and the body 121 applies a bias force to the body 121 so that the second locking part 123 moves to a proper location to restrain the moving of the first locking part 110. The second manner is the cooperation of the first stopping part 150, such as an extrusion, and the second stopping part 160, such as a concave. Referring to FIG. 5A, due to the cooperation of the first stopping part 150 and the second stopping part 160, the second stopping part 160 unilaterally restrains the first stopping part 150 along the first sliding direction D1. Additionally, the cooperation of the first stopping part 150 and the second stopping part 160 also makes the second stopping part 160 restrain the first stopping part 150 along the second sliding direction D2. Note that the function described above still can be achieved even if the first stopping part 150 is a concave, and the second stopping part 160 is an extrusion.

Note that the restrained directions of the second locking part 123 and the second stopping part 160 are parallel to the first sliding direction D1, yet they are in opposite directions. It means that the second locking part 123 restrains the first locking part 100 along the first sliding direction D1 to move in the direction away from the second stopping part 160, i.e., the positive direction of the X-axis; the second stopping part 160 restrains the first stopping part 160 to move in the direction away from the second locking part 123, i.e., the negative direction of the X-axis.

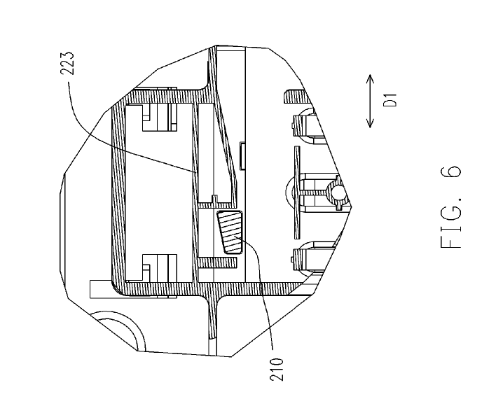

In this embodiment, the second locking part 123 unilaterally restrains the moving of the data storage device 200 along the first sliding direction D1. The present invention, however, is not limited thereto. FIG. 6 is a schematic cross sectional view showing that a second locking part restrains a first locking part according to another embodiment of the present invention. Referring to FIG. 6, the second locking part 223 of FIG. 6 bilaterally restrains the moving of the first locking part 210 along the first sliding direction D1.

Referring to FIG. 5A, if the data storage device 200 is to be removed form the frame 300, a force which is larger than the bias force and with an opposite direction should be applied to the body 121, because the body 121 is subject to the bias force. As a result, the second locking part 123 moves along the second sliding direction D2 and in the positive direction of the Y-axis. The second locking part 123 then does not restrain the upward moving of the first locking part 110 along the first sliding direction D1 and in the positive direction of the X-axis. Meanwhile, a force which is parallel to the first sliding direction D1 and in the positive direction of the X-axis is applied to the data storage device 200 until the data storage device 200 follows the support sheets 303 (in FIGS. 2A and 2B) completely moving out of the frame 300.

Accordingly, the present invention provides a positioning apparatus for a data storage device which not only conveniently assembles/disassembles the data storage device on/from a frame and firmly installs the data storage device on the frame, but also substantially reduces the number of separable elements of the positioning apparatus so as to reduce manufacturing costs of and assembly steps for the positioning apparatus.

Although the present invention has been described in terms of exemplary embodiments, it is not limited thereto. Rather, the appended claims should be constructed broadly to include other variants and embodiments of the invention which may be made by those skilled in the field of this art without departing from the scope and range of equivalents of the invention.

What is claimed is:

1. A positioning apparatus for a data storage device, the positioning apparatus being adapted to install the data storage device in a frame, wherein the data storage device is movable into the frame along a first sliding direction, and the position apparatus comprises:
a first locking part, connecting with the data storage device; and
a locking module, comprising a body, a second locking part and an elastomer, wherein the body is movable outside of the frame along a second sliding direction, the second locking part connects with the body, the elastomer is disposed between the body and the frame, and applies a bias force to the body relative to the frame,
when the data storage device is at a preset location of the frame, the elastomer forces the second locking part to restrain the first locking part to move along the first sliding direction, and
when the data storage device is at the preset location of the frame, the body moves along the second sliding direction so that the second locking part does not restrain the first locking part to move along the first sliding direction, and the data storage device is adapted to move away from the preset location along the first sliding direction by a external force.

2. The positioning apparatus of claim 1, wherein the second sliding direction is substantially orthogonal to the first sliding direction.

3. The positioning apparatus of claim 1, wherein the elastomer forces the second locking part to unilaterally restrain the first locking part to move along the first sliding direction so that the data storage device moves to the preset location.

4. The positioning apparatus of claim 1, further comprising a fixing part, which connects with the data storage device, the first locking part connecting with the fixing part.

5. The positioning apparatus of claim 1, further comprising a fixing part and a ground clip, wherein the fixing part connects with the data storage device and the ground clip connects with the fixing part.

6. The positioning apparatus of claim 1, further comprising:
a first stopping part, connecting with the data storage device; and
a second stopping part, corresponding to the first stopping part and connecting with the frame,
when the data storage device is at the preset location, the second stopping part at least restrains the first stopping part to move along the first sliding direction so as to restrain the data storage device, which is at the preset location, to move along the first sliding direction.

7. The positioning apparatus of claim 6, further comprising a fixing part, which connects with the data storage device, the first locking part and the first stopping part connect with the fixing part.

8. The positioning apparatus of claim 6, wherein the first stopping part is an extrusion, the second stopping part is a concave, which is integrated on the frame and adapted to restrain the extrusion to move along the first sliding direction.

9. The positioning apparatus of claim 6, wherein the first stopping part is an extrusion, the second stopping part is a concave, which is integrated on the frame and adapted to restrain the extrusion to move along the first sliding direction and the second sliding direction.

10. The positioning apparatus of claim 1, wherein the body, the second locking part and the elastomer of the locking module are integrated as a unity.

11. The positioning apparatus of claim 1, wherein the frame comprises a pair of support sheets to support the data storage device.

12. The positioning apparatus of claim 1, wherein the elastomer comprises at least one S-shape elastic strip, and two ends of the S-shape elastic strip connect to the body and the frame respectively.

13. The positioning apparatus of claim 1, wherein the elastomer is a spring.

14. The positioning apparatus of claim 1, wherein the elastomer is a clip.
